(19) United States
(12) Patent Application Publication
(10) Pub. No.: US 2019/0048654 A1
(43) Pub. Date: Feb. 14, 2019

(54) PRIVACY DEVICE

(71) Applicant: Terry Alan Varney, Hillsboro, OR (US)

(72) Inventor: Terry Alan Varney, Hillsboro, OR (US)

(21) Appl. No.: 15/671,261

(22) Filed: Aug. 8, 2017

(51) Int. Cl. E06B 9/24; B60R 11/00

(52) U.S. Cl. CPC E06B 9/24; B60R 11/00; B60R 2011/0056; B60R 2011/004; E06B 2009/2423

(57) ABSTRACT

A privacy device which comprises at least one substantially opaque member; and a plurality of attachment means in communication with a perimeter of the at least one substantially opaque member, wherein the plurality of attachment means connect the perimeter to a surface.

### CROSS-REFERENCE TO RELATED APPLICATION(S)

Not applicable

### BACKGROUND OF THE INVENTION

### 1. Field of Invention

The present invention relates to the field of visual blocking elements. More particularly to a releasable privacy elements selectively attachable to surfaces.

### 2. Description of Related Art

People who experience outdoor activities often have a need for privacy for one or more reasons. Where the outdoor activities include traveling to a remote destination, or participating in activities in an area without established facilities, the ability for the participant to privately address personal issues is greatly limited.

Voyeurism is arguably an inherent human trait to appreciate one's surroundings often involves people watching or general curiosity into the activities of others. Whether the visual intrusion is accidental or intentional, it can be harmful to someone's integrity and right to privacy.

An illustrative example of people enjoying outdoor activities would be surfing. Unless the individual lives right on the beach, they do not have the ability to find a private area to change, clean off, or attend to other personal matters.

Other examples would include skiers, snowboarders, bikers, and men/women/children in general that need more privacy than just a towel can offer. There is an element of danger for someone trying to change next to a vehicle, as the physical activity can leave the person changing exposed and vulnerable as well as susceptible to unwanted visual intrusion.

While attempts have been made to provide temporary privacy shelters, they often involve complex setup procedures manifesting in a large number of pieces and structural elements to support the privacy shade.

One example of the current state of the art would be U.S. Pat. No. 8,708,027 to Howie, et al., titled ‘Portable privacy shield for an automobile”. The example illustrates a frame structure and complex tie straps that have to be affixed to the vehicle.

Current attempts result in an extremely niche application of any device based on the substrate it is being attached to. The adaptability of such references illustrates a failure to adapt the privacy device to various substrates and structures restricting the user to a limited number of deployment options.

Based on the foregoing, there is a need in the art a device, providing privacy from visual intrusion while allowing for deployment in a multitude of situations and onto a multitude of different structures or substrates.

### SUMMARY OF THE INVENTION

A privacy device which comprises at least one substantially opaque member; and a plurality of attachment means in communication with a perimeter of the at least one substantially opaque member, wherein the plurality of attachment means connect the perimeter to a surface.

In an embodiment, the device further comprises a plurality of substantially opaque members, wherein each of the plurality of opaque members releasably engage one another, wherein the device has an adjustable length defined by a distance between the attachment means on a first side perimeter and the plurality of attachment means on a second side perimeter, wherein the first side and the second side are opposite one another.

In an embodiment, the plurality of attachment means is selected from a group consisting of suction cups, hook and loop fasteners, clips, and adhesive members.

In an embodiment, the plurality of attachment means is a suction cup having a circumference around a suction portion, wherein a shaft extends outward and away from a suction surface, wherein the shaft extends through an aperture extending through the at least one substantially opaque member, wherein the aperture is disposed substantially near the perimeter.

In an embodiment, a locking mechanism engages the shaft, wherein the at least one opaque member is retained on the shaft between the suction portion and the locking mechanism.

In an embodiment, the shaft has a threaded exterior and the locking mechanism is threadingly engaged with the shaft.

In an embodiment, at least one opaque member further comprises a flexible and resilient perimeter, wherein the flexible and resilient perimeter facilitate an open position of the at least one opaque member, wherein the open position is defined by full extension of the at least one substantially opaque member.

In an embodiment, the flexible and resilient perimeter is defined by a length of resilient metal disposed about the perimeter of the at least one substantially opaque member. [THIS IS A VARIATION THAT I WAS INCLUDING AS A CREATIVE ALTERNATIVE OPTION]

In an embodiment, the plurality of attachment means connect at least one substantially opaque member to a surface through a method comprising the steps of first, installing the plurality of attachment means to the perimeter of the at least one substantially opaque member. Then a first side of the at least one substantially opaque member is attached to a surface. A second side of the substantially opaque member is stretched away from the first side until the at least one substantially opaque member is taught. Finally, the second side is attached to a second surface.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a perspective view of the privacy device, according to an embodiment of the present invention;

FIG. 2 is a perspective view of the privacy device, according to an embodiment of the present invention;

FIG. 3 is a perspective view of the privacy device, according to an embodiment of the present invention;

FIG. 4 is a perspective view of the privacy device, according to an embodiment of the present invention;

FIG. 5 is a perspective view of the privacy device, according to an embodiment of the present invention;

FIG. 6 is a perspective view of the privacy device, according to an embodiment of the present invention;

FIG. 7 is a perspective view of the privacy device, according to an embodiment of the present invention;

FIG. 8 is a perspective view of the privacy device, according to an embodiment of the present invention;

FIG. 9 is a perspective view of the privacy device, according to an embodiment of the present invention;

FIG. 10 is a perspective view of the privacy device, according to an embodiment of the present invention;

FIG. 11 is a perspective view of the privacy device, according to an embodiment of the present invention;

FIG. 12 is a perspective view of the privacy device, according to an embodiment of the present invention;

FIG. 13 is a perspective view of the privacy device, according to an embodiment of the present invention; and

FIG. 14 is a perspective view of the privacy device, according to an embodiment of the present invention.

### DETAILED DESCRIPTION OF PREFERRED EMBODIMENTS

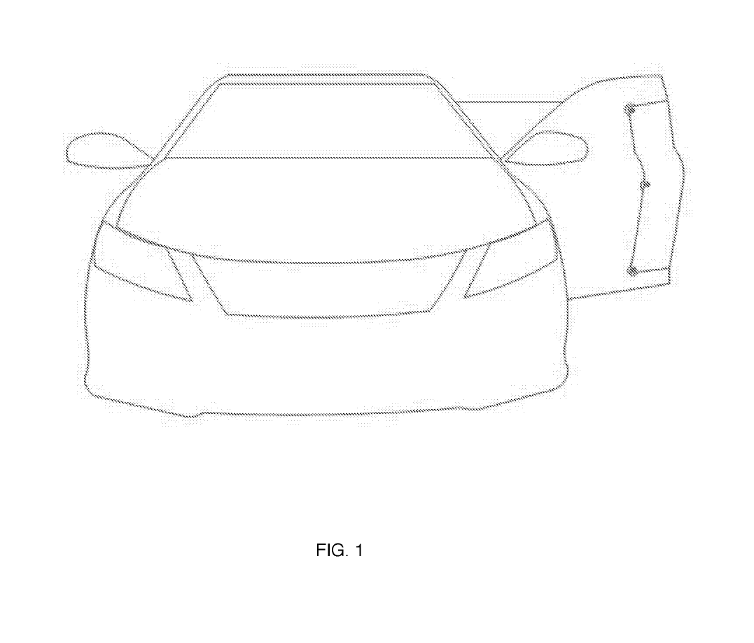

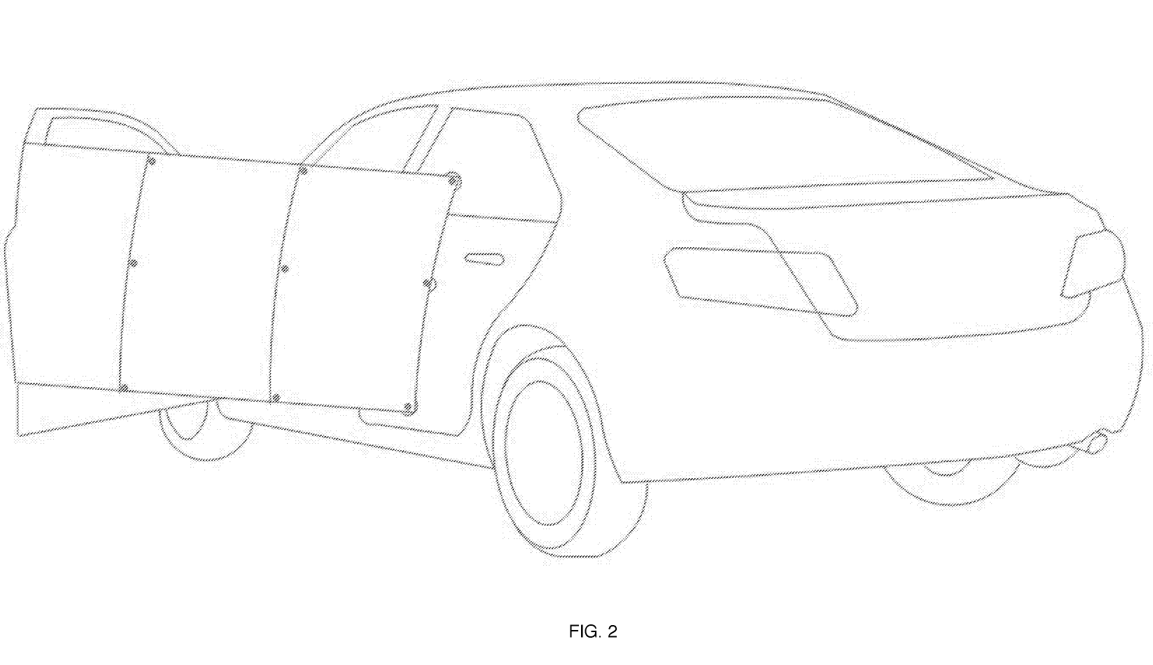

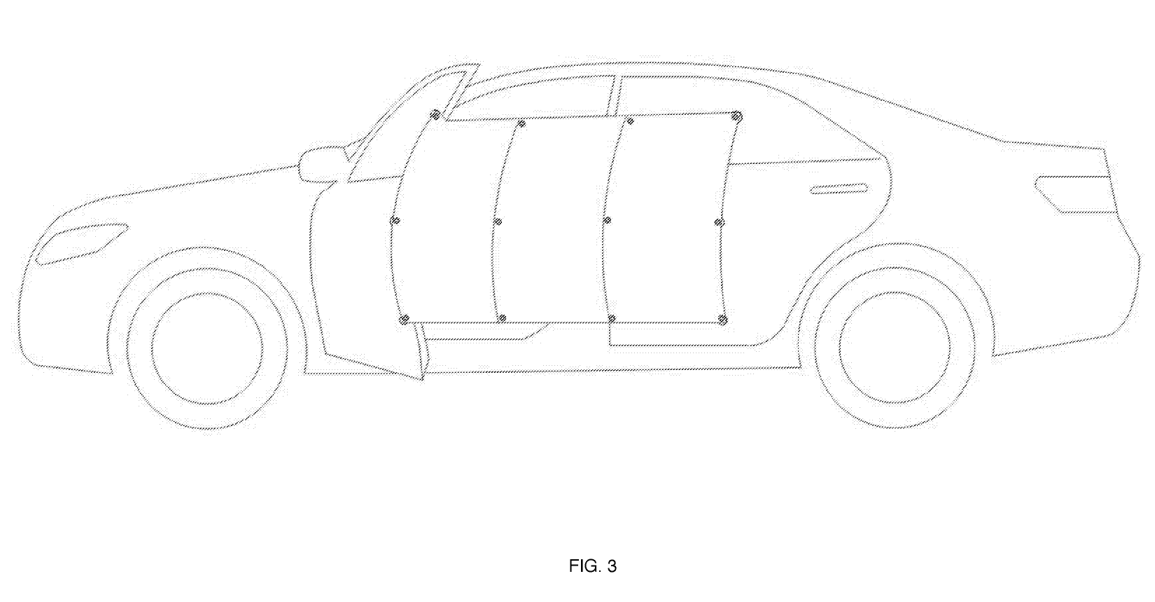

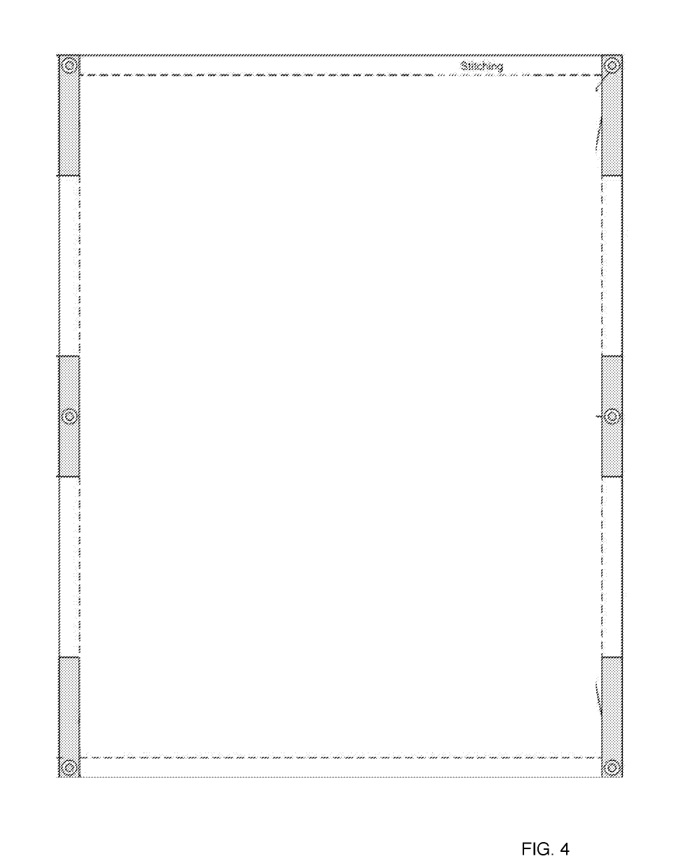

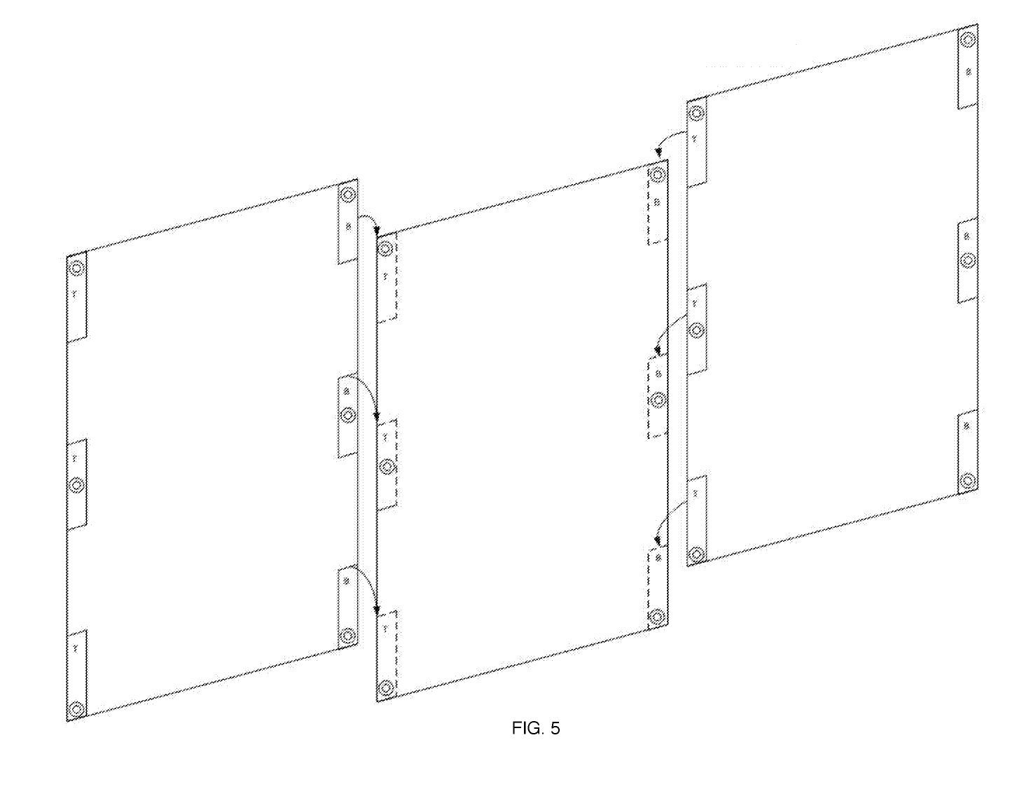

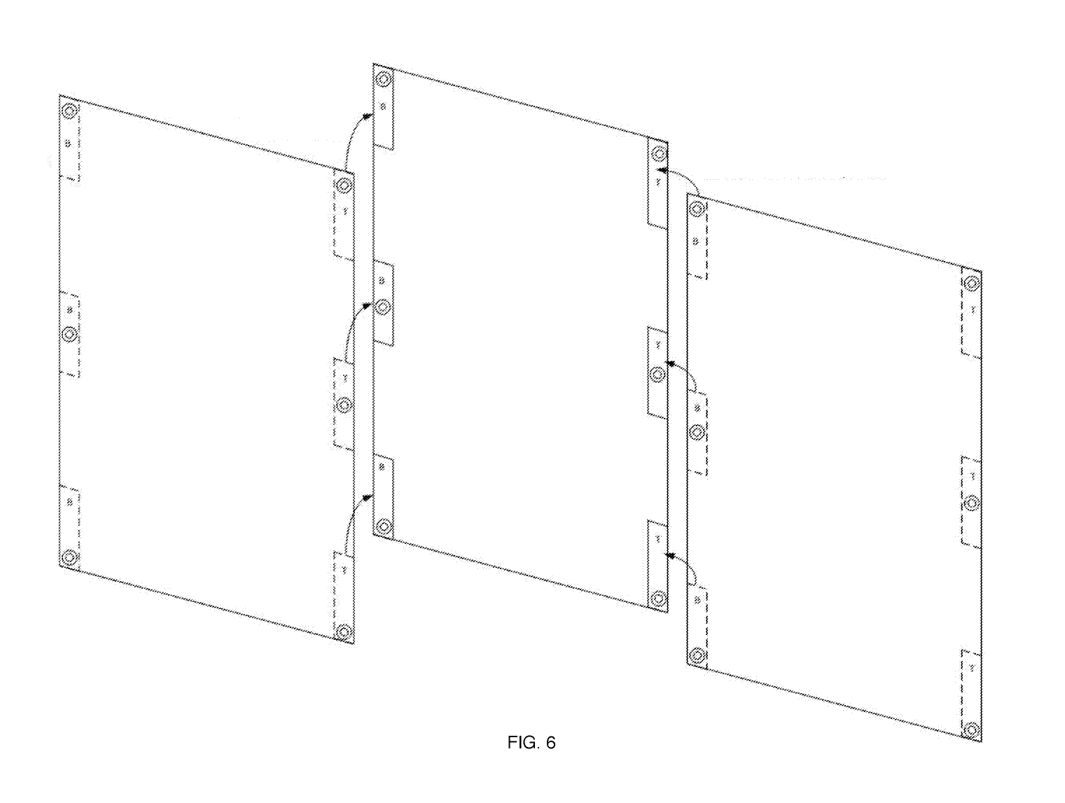

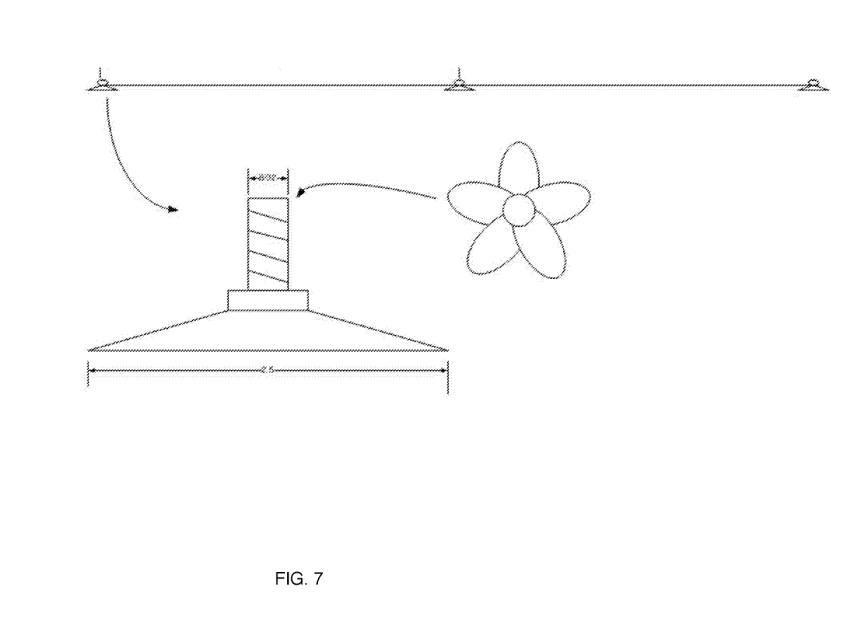

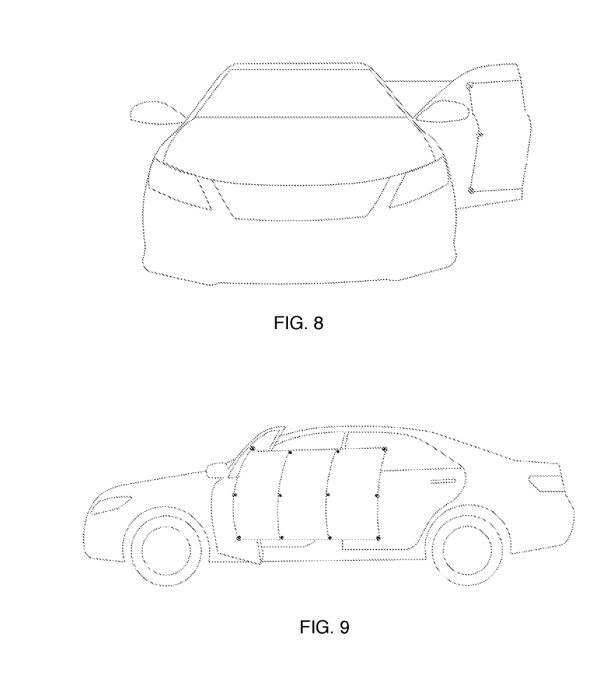

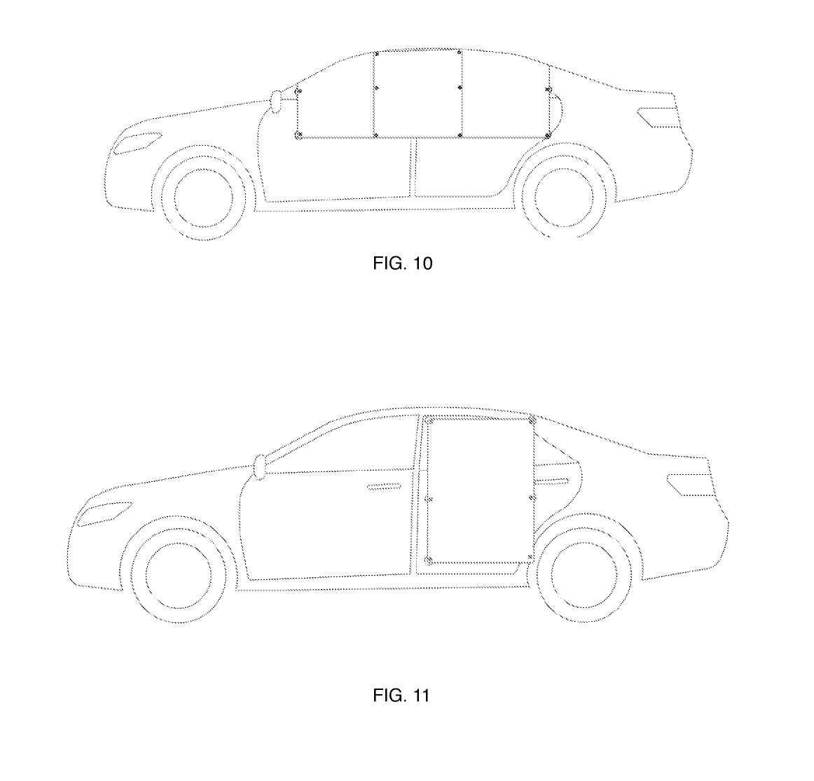

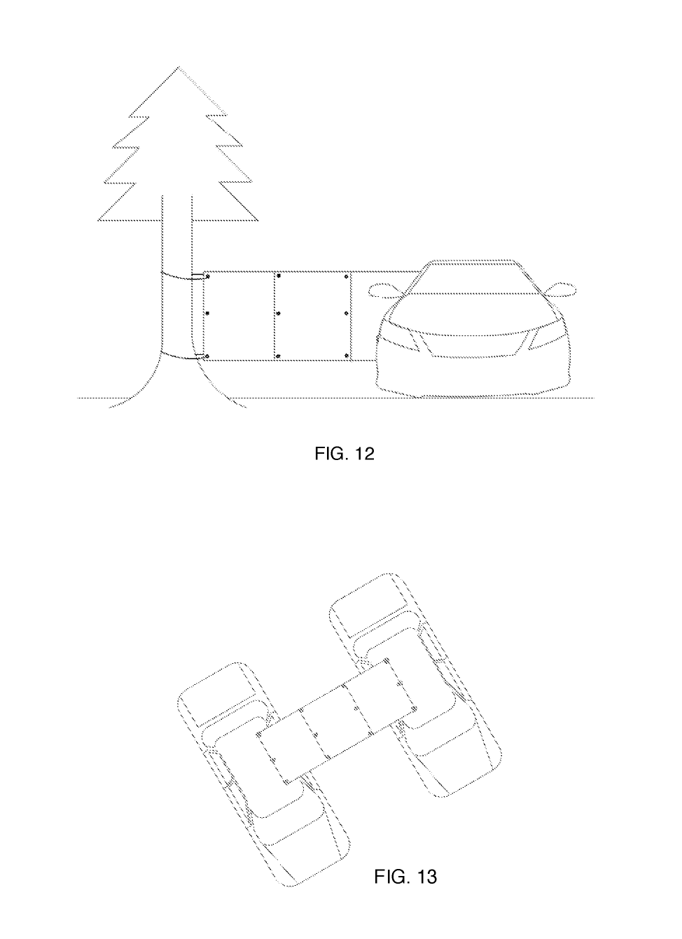

Preferred embodiments of the present invention and their advantages may be understood by referring to FIGS. 1-14.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

A privacy device has a section of material with a plurality of attachment means disposed about a perimeter of the material. The attachment means are physically engaged to the material and are configured to engage a separate surface.

In an embodiment, the material is provided in a number of sections. For example, where the material is a textile such as a towel material, the sections would comprise the same material is a means for attaching the sections to one another.

The means for attaching the material sections to one another may include clips, snaps, or a hook and loop fastening system. For example, each section may have a means for attaching the sections to one another on an interior surface and an exterior surface. The interior surface is defined by the side or surface of the material proximal to the structure to which the device is attached. The opposite side of the device is viewed as the exterior surface.

In an embodiment, the attachment means has a suction portion to engage the surface when the device is deployed. The suction portion may be generally circular or conical. A shaft may extend outward from the suction portion of the attachment means. The shaft extends generally from a central axis of the suction portion. The shaft is configured to engage the material at or near the perimeter. The position of the attachment means is optimized to allow for the deployment of the device and optimizing the coverage and surface area of the material used to provide privacy.

In an embodiment, the exterior surface is provided with a visual design.

### In Use

The privacy device is deployed against an existing structure whereby the attachment means are releasably attached to the surface at various points. The points of attachment are predetermined by the user to optimize the coverage of the material.

In the method of deployment, the attachment means, disposed around a perimeter of the material, are affixed to the material on one end and a second end of the attachment means engages the surface of the structure to which the device is attached.

A first side of the material is attached to the substrate or structure. Then the remaining perimeter of the device is attached to the structure, where the structure permits.

In an exemplary embodiment, the structure is a vehicle. The vehicle has one or more doors that may be opened and form a secure location having the surfaces of the vehicle and the device covering any possibly viewable interior of the private area. Where the structure is a vehicle, the first side of the material is releasably attached to an exterior surface, or surface of the vehicle near the body, when a door is in an open position. The door opens as it rotates about a hinge axis, where it is attached to the body of the vehicle. The edge of the door, opposite of the hinge axis provides for a second attachment point whereby the material is stretched from the body of the vehicle to the edge of the door.

In an alternative embodiment, the device is deployed exclusively on an exterior surface of the vehicle. For example, where the user requires a private environment within the vehicle, the device operates to transition an otherwise translucent or transparent window of the vehicle to an opaque private surface. In such an embodiment, the material is attached to the exterior surface through the use of suction cups, which releasably engage the interior of the vehicle. In yet another embodiment, the device may be deployed on an interior surface of a vehicle window.

The method may also include predetermining a number of sections of material necessary to span the length of the open area to be covered by the device. For example, where the door edge extends away from the body further than the initial length of material, additional sections may be added to the material to provide for additional extension needed to bridge the distance between the body and the door edge.

Where the device comprises multiple lengths of material, the different sections releasably engage one another at their respective perimeters. For example, each section may have a hook and loop fastener means positioned around the perimeter and allowing for a releasable, yet positive engagement with other sections.

In an alternative embodiment, the substantially opaque material is rigid or semi rigid. In such an embodiment, the material is folded out to meet the predetermined length. Each section of the material may be folded within one another such that, once the user predetermines the length, the corresponding number of sections required to meet the predetermined length. As the sections are folded out from one another, their engagement bay rely on a hinge, perforation, or other compressed seam to structurally separate each section and allow for a folding and hinged engagement between the sections.

In an alternative embodiment, the attachment means is a frame structure defined by a number of frame members which are articulable relative to one another. The frame members are attached to one another and configured to provide a substructure for the material to cover. For example, the frame members may be positioned between the exterior surface of the door of a vehicle and the body of the vehicle. The material is then draped or otherwise releasably attached to the frame substructure.

In another embodiment, the material is generally rectangular and comprises a separate section configured to engage the material along a long side of the rectangular material. The separate section can then be folded or repositioned about the attachment line with the material to provide for coverage over the user. For example, the separate section may form a roof-type cover in the event of rain or other inclement weather.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A privacy device comprising:
a. at least one substantially opaque member; and
b. a plurality of attachment means in communication with a perimeter of the at least one substantially opaque member, wherein the plurality of attachment means connect the perimeter to a surface.

2. The device of claim 1, further comprising a plurality of substantially opaque members, wherein each of the plurality of opaque members releasably engage one another, wherein the device has an adjustable length define by a distance between the attachment means on a first side perimeter and the plurality of attachment means on a second side perimeter, wherein the first side and the second side are opposite one another.

3. The device of claim 1, wherein the plurality of attachment means is selected from a group consisting of suction cups, hook and loop fasteners, clips, and adhesive members.

4. The device of claim 1, wherein the plurality of attachment means is a suction cup having a circumference around a suction portion, wherein a shaft extends outward and away from a suction surface, wherein the shaft extends through an aperture extending through the at least one substantially opaque member, wherein the aperture is disposed substantially near the perimeter.

5. The device of claim 4, wherein a locking mechanism engages the shaft, wherein the at least one opaque member is retained on the shaft between the suction portion and the locking mechanism.

6. The device of claim 5, wherein the shaft has a threaded exterior and the locking mechanism is threadingly engaged with the shaft.

7. The device of claim 1, wherein the at least one opaque member further comprises a flexible and resilient perimeter, wherein the flexible and resilient perimeter facilitate an open position of the at least one opaque member, wherein the open position is defined by full extension of the at least one substantially opaque member.

8. The device of claim 7, wherein the flexible and resilient perimeter is defined by a length of resilient metal disposed about the perimeter of the at least one substantially opaque member.

9. The device of claim 1, wherein the plurality of attachment means connect the at least one substantially opaque member to a surface through a method comprising the steps of:
a. installing the plurality of attachment means to the perimeter of the at least one substantially opaque member;
b. attaching a first side of the at least one substantially opaque member to a surface;
c. stretching a second side away from the first side until the at least one substantially opaque member is taught; and
d. attaching the second side to a second surface.
